(19) United States
(12) Patent Application Publication
(10) Pub. No.: US 2007/0059398 A1
(43) Pub. Date: Mar. 15, 2007

(54) Process for preparing a modified dairy product

(75) Inventors: Richard Hamilton Archer, Palmerston North (NZ); Derek Haisman, Feilding (NZ)

Correspondence Address: KNOBBE MARTENS OLSON & BEAR LLP, 2040 MAIN STREET, FOURTEENTH FLOOR, IRVINE, CA, 92614, US

(73) Assignee: FONTERRA CO-OPERATIVE GROUP LIMITED, Auckland (NZ)

(21) Appl. No.: 10/563,165

(22) PCT Filed: Jul. 2, 2004
(86) PCT No.: PCT/NZ04/00140

§ 371 Date: Aug. 1, 2006

(30) Foreign Application Priority Data
Jul. 2, 2003 (NZ) 526804

(51) Int. Cl. A23C 9/12

(52) U.S. Cl. 426/36

(57) ABSTRACT

The invention provides a method of preparing or modifying a cheese or cheese-like product comprising mixing into a cheesemaking mixture or a product, a heat-killed ferment of an exopolysaccharide-producing-microorganism without separating the exopolysaccharide from the other components of the ferment. The invention also provides an analogous method for modifying a milk protein concentrate.

### TECHNICAL FIELD

The present invention relates to production of cheese and cheese-like products containing bacterial exopolysaccharides.

### BACKGROUND ART

Bacterial exopolysaccharides (EPS) are well known not only for their role in bacterial structure but also as food ingredients. In particular they have been found useful as thickeners and stabilisers in food products (Weinbreck et al., Polymerix 2000. Symposium europeen Polymerix 2000. European symposium Rennes 2000-06-07).

In many cases the EPS are used in situ to improve the texture of such products as yoghurt, cheese and desserts (e.g. Duboc and Mollet, Int Dairy J 11,759-768, 2001). In other cases the exopolysaccharide is isolated first, and then added to the food.For example the fermentation of Xanthomonas campestris is well known for the production of an exopolysaccharide which may be isolated to form xanthan gum widely used in the food and pharmaceutical industries (Powell, In Microbial Polysaccharides and Polysaccharases. R. C. Berkeley, G. W. Gooday, D. C. Ellwood (Ed). Academic Press, Inc. New York pp. 117-160, 1979.; Morris, . In Food Polysaccharides and Their Application. A. M. Stephen (Ed). Marcel Dekker, Inc. pp. 341-375, 1995).

Generally when exopolysaccharide such as xanthan gum are introduced into dairy products such as ice cream, yoghurt, cheese spread and cream cheese, the exopolysaccharide is an extract or purified polysaccharide separated out from a ferment. For example commercial xanthan gum is produced by a process involving treatment with heat and extraction with isopropanol to separate the xanthan gum from the other components of the ferment. For instance, in U.S. Pat. No. 5,434,078, whey permeate is fermented with a constructed strain of Xanthomonas campestris and the xanthan EPS isolated by precipitation with isopropanol, and dried for use as a viscosifier.

Generally an industrial form of glucose is used as a substrate for the microorganisms, but many researchers have attempted to use low value sidestreams from the dairy industry, such as milk or whey permeate, as a cheaper source for the EPS. However, many microorganisms only poorly utilise these substrates.

Another approach to increasing the exopolysaccharide content of a dairy product is to include live microorganisms in the product (Broadbent et al., 11, 433-439.2001; Christiansen et al., Milchwissenschaft 54, 138-140. 1999; Perry et aL, J Dairy Sci, 81, 799-805, 1997).

Both of these approaches have disadvantages. The processing steps required for separation of the exopolysaccharide from a fermentation mixture mean that such exopolysaccharide preparations are expensive and may contain traces of precipitating agent. The addition of live microorganisms creates problems in controlling the amount and quality of the exopolysaccharide added. Also addition of live microorganisms may lead to incorporation of byproducts of the microorganism into the dairy product.

It is an object of the present invention to provide a simple controlled process for producing and adding exopolysaccharide to a cheese or cheese-like products, or at least to provide the public with a useful choice.

### DISCLOSURE OF THE INVENTION

In one aspect, the invention provides a process for preparing or modifying a cheese or cheese-like product comprising mixing into a cheese making mixture, or a product, a heat-killed ferment of an exopolysaccharide-producing-microorganism without separating the exopolysaccharide from the other components of the ferment.

A “cheese-like product” is a milk protein-containing product which on being consumed by consumer imparts the sensation of consuming cheese. The products of the process include processed cheese and processed cheese spread, cottage cheese and petit suisse. Particularly referred products include processed cheese and processed cheese spread. The term “cheese-like product” includes products which may not be considered to be cheeses by some regulatory authorities.

The heat-killed ferment may be directly mixed into the cheesemaking mixture.

Alternatively the ferment may be mixed into an ingredient used in making the product.

Preferably the heat-killed ferment is a ferment prepared using a lactose-rich medium and an exopolysaccharide-producing-microorganism. In some cases where the microorganism does not hydrolyse lactose, the ferment will require addition of a lactase or galactosidase enzyme or an organism which produces an enzyme which hydrolyses lactose. A lactose-rich medium is a medium containing more than 0.5% (w/v) lactose, preferably more than 1.0% (w/v).

Preferably the lactose-rich medium is a fraction of milk such as skim milk or buttermilk or whey or serum or mother liquor; or raffinate or breakthrough derived from milk or skim milk or buttermilk or whey or serum or mother liquor or permeate; or permeate derived from milk or skim milk or buttermilk or whey or serum or mother liquor or raffinate or breakthrough.

Preferably the microorganism is a food-acceptable microorganism.

Preferably the lactose-rich medium comprises a dairy permeate.

Preferably the dairy permeate is a milk permeate or a whey permeate.

When a dairy permeate is used the invention provides the advantage that a readily available by-product of a dairy factory is used without the disadvantage of having to further process and transport it to other sites. In addition in this aspect the invention allows combinations of dairy streams generated within the same plant to be used to provide product with enhanced value.

Preferred microorganisms for use in the invention are Xanthomonas campestris, Sphingomonas paucimobilis and lactic acid bacteria.

Currently particularly preferred are Xanthomonas campestris and Sphingomonas paucimobilis which produce exopolysaccharides known as xanthan and gellan respectively.

Lactic acid bacteria useful in process of the invention include Lactobacillus delbrueckii ssp bulgaricus; Lactococcus lactis ssp cremoris; Lactococcus lactis ssp lactis; Streptococcus salivarius ssp thermophilus; Lactobacillus casei ssp casei; Leuconostoc mesenteroides; Lactobacillus helviticus; Lactobacillus reuteri; Lactobacillus rhamnosus; Lactobacillus plantarum; Lactobacillus sakei.

Generally, the fermentation conditions are selected to maximise the yield and quality of exopolysaccharide.

Typically the incubation is conducted at a temperature of 20-35° C.

Typically the microorganism is added to a dairy permeate medium with added nutrients for the microoganism such as appropriate salts, a supplementary nitrogen source and a yeast extract. The mixture is then typically incubated for 16-240 hours, generally 60-120 hours. The exopolysaccharide concentration may be determined. At this stage the ferment may be heated and spray dried and subsequently added to a cheese making mixture or an ingredient. Alternatively the ferment may be heat-killed and mixed directly with the cheese making mixture or ingredient. The methods of the invention are distinguishable over those generally used in the prior art in that there is no separation of the exopolysaccharide from the medium. In addition to saving on costs, this avoids any harsh extraction process which may modify the properties of the exopolysaccharide. The process is distinguishable and advantageous over those involving incorporating live organisms in that the amount and quality of exopolysaccharide added can be more readily controlled, for example the exopolysaccharide concentration may be measured and the incubation conditions such as the carbon:nitrogen ratio readily adjusted and controlled.

Exopolysaccharide-containing heat-killed ferment may be added to milk or milk protein concentrate to be used in cheese manufacture. Use of such modified milk or milk protein concentrate in conventional cheese making process and in which a proteolytic enzyme is added to cheese milk to produce a curd has the advantage of minimising loss of whey proteins during the cheese making process. Thus the invention provides an embodiment which is a process of preparing a cheese or cheese-like product comprising the steps of
(a) adding to a cheese milk a heat-killed ferment of an exopolysaccharide-producing-microorganism without separating the exopolysaccharide from the other components of the ferment;
(b) adding a proteolytic enzyme to the mixture;
(c) collecting the resulting curd; further processing the curd to produce a cheese or cheese-like product.

The process of the invention may also be used during processing of cheese curd to prepare processed cheese or in other types of cheese making process such as the process of U.S. Pat. No. 6,177,118 and other processes for making cheese without using enzymatic hydrolysis such as those of U.S. Pat. No. 6,183,805 and 6,183,804 and PCT international patent application W003/51130. Thus the invention provides an embodiment which is a process of preparing a cheese or cheese-like product comprising the steps of
(a) providing a cheese precursor mixture comprising milk proteins
(b) adding to the cheese precursor mixture a heat killed ferment of an exopolysaccharide-producing-microorganism without separating the exopolysaccharide from the other components of the ferment
(c) providing conditions under which the product gels.

Typically the conditions of (c) are provided by adding a proteolytic enzyme which will set the milk to a curd.

In another aspect the invention provides a process for the modification of a milk protein concentrate comprising adding to the concentrate a heat-killed ferment of exopolysaccharide-producing-microorganism without separating the exopolysaccharide from the other components of the ferment. Such milk protein concentrates may be used in cheese extension. When such a milk protein concentrate is added to the milk to be used in a cheese making process, it provides the advantage of a high yield of cheese as do milk protein concentrates generally. In addition there is the further advantage of having improved retention of whey proteins in the cheese. Also the presence of the exopolysaccharide modifies the consistency of the cheese in a manner which is desirable in some cheese types.

Preferred embodiments of the invention will now be described with reference to accompanying drawings.

### BRIEF DESCRIPTION OF THE DRAWINGS

FIG. 1 shows a graph of the viscosity of reconstituted WMP (15% in water) containing ferment broth EPS at various concentrations, over a range of shear rates.

FIG. 2 shows the viscosity of reconstituted WMP (15%) in water, over a range of shear rates, compared to a test reconstituted WMP (13.3%) containing 0.02% xanthan EPS.

FIG. 3 shows a graph of the viscosity of reconstituted WMP (20%) in water, over a range of shear rates, compared to test reconstituted milks (15%) containing xanthan EPS.

### EXAMPLES

The following examples further illustrate practice in the invention. Where the basis of percentages has been omitted, it is w/w for solids, w/v for solids in liquids and v/v for liquids.

### Example 1

Sphingomonas paucimobilis (ATCC 31461) was cultured on milk permeate in a number of shake flasks to produce viscous broths containing the anionic polysaccharide known as gellan.The inoculum of Sphingomonas paucimobilis was maintained in trypticase soy broth, and introduced into the fermentation medium at 2.5% (v/v). The milk permeate medium (milk permeate containing 0.1% yeast extract (Difco)) was free-steamed at 100° C. for 10 min prior to inoculation of the culture and subsequent fermentation. The pH of the media was not adjusted prior to heating. Each 250 ml shake flask contained 25 ml of milk permeate and was incubated on an orbital shaker for 96 hours at 30° C.

After incubation the flasks were analysed for polysaccharide as follows. An aliquot of the ferment (1 g) was weighed into a centrifuge tube, heated to boiling for 10 minutes, and then mixed with 2 ml of ethanol (99%). The floccular precipitate was centrifuged down at 12,000 RCF, and the supernatant discarded. The pellet was redissolved in 1.5 ml water, and re-precipitated with 3.5 ml of 99% ethanol. After re-centrifugation, the pellet was dissolved in water and made up to 200 ml. Aliquots (1 ml) of this solution were mixed with 1 ml of phenol solution (5%, freshly prepared). Concentrated sulphuric acid (5 ml) was added, and the absorbance of the solution measured at 485 mn after standing for 30 minutes. The polysaccharide concentration, in glucose equivalents, was calculated from the absorbance, after subtraction of the blank value from a water sample, by reference to a calibration plot constructed from assays using pure glucose.

Twenty flasks were combined to make a total of 3.7 g of polysaccharide. This was diluted to 750 ml, with reverse osmosis (RO) water and intimately mixed with 750 ml of reconstituted whole milk (20% solids in RO water). The milk was heated to 50° C. and then into a spray drier, with an inlet temperature of 180° C. and an outlet temperature of 90° C. A free-flowing powder was collected, and the. gellan content was determined by the same method as before after first hydrolysing the milk protein by incubation with a protease (Flavourzyme, Novozyme). The gellan content was found to be 2.5% on the milk solids.

The powder was dissolved in RO water to make solutions of 10, 15 and 20% solids. Control samples at the same concentration were prepared with spray dried whole milk powder without added polysaccharide. The viscosities of the different milks were measured at 25° C., using a capillary viscometer (Cannon-Fenske, Size 300). The powder containing the polysaccharide made a much thicker milk, as shown in Table 1.

TABLE 1
The viscosity of homogenised whole milks
with and without added polysaccharide.

Viscosity (mPa · s)

| | | With 2.5% polysaccharide |
|---|---|---|
| Solids level (%) | Control | (on powder) |
| 10 | 1.25 | 5.8 |
| 15 | 1.39 | 26.4 |
| 20 | 1.62 | 54.1 |

The whole milk containing polysaccharide could be made into cheese by the addition of rennet and then draining the curds of whey. It would be expected to give a higher yield of cheese curd.

### Example 2

Xanthomonas campestris (ATCC 13951) was maintained on “YM” agar and reconstituted in “ISP” medium. It was inoculated (5% v/v) into a fermentation medium consisting of lactase-treated milk permeate (60% of the total volume), urea (0.10% w/v), K₂HPO₄ (0.20% w/v), and MgSO₄.7H₂O (0.01% w/v). The urea and minerals were sterilized separately, and pooled with the hydrolysed milk permeate which had been steamed at 100° C. The final medium pH was 7.0.

Fermentations were undertaken in shake-flasks (250 ml) in 100 ml volumes. The flasks were incubated for 96 hours at 28° C. with agitation at 180 rpm on an orbital shaker. After this time the medium had become a viscous, pale yellow broth, with a slightly unpleasant odour.

Eight flasks were then combined and passed through a pressurized filter bed (18 mm*125 mm diameter) of granular activated carbon (Norit GAC 1240), which had been washed with 9 bed volumes of water. The viscosity of the broth decreased from 150 mPa·s to 126 mPa·s on the first pass, as it mixed with the water retained in the filter bed, but then remained constant through three further cycles through the bed. This was sufficient to decolourise and deodorise the broth.

After analysis (by the method in example 1) of the EPS content, 700 g of broth, containing 4.9 g of xanthan polysaccharide, was mixed with 485 g milk protein concentrate (70% protein) in 2.2 litres of RO water. The mixture was homogenised with a Silverson overhead homogeniser for 5 minutes, passed through a sieve (300 μm aperture), warmed to 50° C. and then pumped to a spray-drier. The inlet temperature was 180° C., and the flow rate of the milk feed was adjusted to maintain the outlet temperature between 80 and 90° C.

A free flowing powder was collected and found to contain 1.056% xanthan polysaccharide, by the same analytical methods used in Example 1. This powder was used to make a soft white cheese, similar to the South American cheeses known as Panela or Queso Fresco. The basic composition of the cheese was 14 to 18% protein, 10 to 12% milk fat and 70 to 75% moisture. The cheese made was made by mixing a milk fat emulsion with milk protein concentrate, acidifying, adding salt and then incubating with rennet until the cheese was set.

Milk protein concentrate (20 g) was dispersed in 480 g of RO water at 50° C. Melted milk fat (500 g) was added, and a coarse emulsion made with a Silverson homogeniser. This was then fully homogenised in a Rannie homogeniser at 70/50bar.

Two milks were then prepared, one with control spray dried milk protein concentrate, and one with the milk protein concentrate containing 1.056% xanthan polysaccharide. The milk protein concentrate (170 g) was dispersed in 494 g RO water at 50° C. in a pestle and mortar. The solution was stirred with a Heidolph RZR 50 stirrer for one hour, and then passed through a 300 μm sieve.

Six different cheese milks were then prepared according to Table 2, by mixing the milk base, the fat emulsion, the water and lactic acid (2%) at 50° C., then adding the salts.

The temperature of the milks was then adjusted to just under 38° C., the rennet (Chymax) was added and then the milks were distributed into pottles and placed in an incubator at 38° C. for 40 minutes to coagulate. The pottles were then transferred to a cool room at 4° C. and cooled overnight.

TABLE 2
Formulation of the cheese milks

| | Control | Xanthan | | | Calcium | Lactic Acid | | |
|---|---|---|---|---|---|---|---|---|
| | Milk Base | Milk Base | Emulsion | NaCl | Lactate | Solution | Water | Rennet |
| No | (g) | (g) | (g) | (g) | (g) | (g) | (g) | (μl) |
| 1 | — | 170 | 50 | 3.0 | 0.375 | 30 | — | 40 |
| 2 | — | 140 | 50 | 3.0 | 0.375 | 30 | 30 | 40 |
| 3 | 85 | 85 | 50 | 3.0 | 0.375 | 30 | — | 40 |
| 4 | 70 | 70 | 50 | 3.0 | 0.375 | 30 | 30 | 40 |
| 5 | 170 | — | 50 | 3.0 | 0.375 | 30 | — | 40 |
| 6 | 140 | — | 50 | 3.0 | 0.375 | 30 | 30 | 40 |

The following day, the solids content, texture and whey loss from the cheeses were measured moisture was determined by oven-drying at 102° C. overnight.

The texture of the cheeses was measured with a TA XT2 texture analyser (Stable Micro Systems, Surrey, England), and was conducted a day after samples were made. A scalpel was used to cut away the plastic pottle and 10 mm cubes were cut out of the cheese. Measurements were conducted using the TA XT2 texture analyser at 5° C. using two plates in which the cheese cubes were placed in the centre of the two plates and the force applied. The test speed was 5 mm/s, compressing the cube to 7 mm. The test was carried out a minimum of four times. The results were plotted as force against time, and the area under the graph calculated as a measure of the firmness of the cheese.

For the measurement of free whey, the cheese was cut into 5 mm cubes at 5° C. and placed into a 50 ml centrifuge tube with a cone bottom until a minimum of 5 g had been added. Measurements were carried out in quadruplicate. The cheese was left in an incubator at 21° C. for 3 hours then centrifuged (RCF 112) for 10 minutes. The whey was poured off and weighed. The centrifuge tube was then inverted at 30° for 2 minutes and the residual drained whey added to the weight. The whey loss was calculated as a percentage of the original weight of cheese.

The results for the six cheeses are shown in Table 3. The measured solids in the cheeses corresponded closely to the calculated values of 27.48 and 25.74% for the two levels of protein.

There was little difference in firmness between the samples, except for the cheese with the highest level of xanthan in the milk powder, and the highest level of protein. This cheese was slightly less firm than the others, matching the texture of the samples with the lower level of protein. This type of cheese is characteristically quite soft, and the difference was barely detectable when the cheeses were compared in the mouth.

There were much larger differences in whey loss between the cheeses. The cheese with the highest level of xanthan and protein lost significantly less whey than all the others, and clearly less milk protein concentrate containing this level of polysaccharide would be needed to make cheese of equivalent whey holding capacity to the control sample at this level of protein. The cheese made with 25.74% milk protein concentrate containing 1% polysaccharide was equivalent in whey holding capacity to the cheese with 27.48% protein concentrate. This represents a saving in milk powder of over 6%.

TABLE 3
Properties of Experimental Cheeses

| Milk protein | | | | |
|---|---|---|---|---|
| concentrate | Xanthan | | | |
| (% of | polysaccharide | Total solids | Firmness | Whey Loss |
| cheese) | (% of cheese) | (%) | N · s | (%) |
| 17.57 | 0.186 | 27.57 (0.13) | 3.66 (0.45) | 7.19 (3.49) |
| 17.57 | 0.154 | 28.12 (0.14) | 5.06 (0.43) | 15.64 (0.83) |
| 17.57 | 0 | 28.18 (0.12) | 5.37 (0.30) | 20.01 (0.48) |
| 14.54 | 0.093 | 24.42 (0.1) | 3.58 (0.14) | 14.68 (2.35) |
| 14.54 | 0.077 | 25.16 (0.21) | 3.74 (0.21) | 20.51 (1.88) |
| 14.54 | 0 | 25.37 (0.23) | 3.95 (0.22) | 22.99 (0.45) |

Note:
Standard deviations in brackets

### Example 3

Broth was produced by the fermentation of Xanthomonas campestris strain 13951 on lactase hydrolysed milk permeate containing K₂PO₄ (0.20% w/v), MgSO₄.7H₂O (0.01% w/v), and yeast extract (1.0% w/v).

Yeast malt peptone agar was inoculated with the organism and added to the milk medium at the 5% level.

The fermentation was carried out in shake-flasks (250 ml) in 100 ml volumes. The flasks were incubated for 96 hours at 28° C. with agitation at 180 rpm on an orbital shaker. After this time the medium had become a viscous, pale yellow broth, with a slightly unpleasant odour. Several flasks were then combined and analysed for EPS content by the method in example 1, ready for spray drying on to skim milk powder (SMP).

Reverse Osmosis (RO) water was heated to 50° C. Under constant agitation with a Heidolph RZR 50 overhead stirrer, WMP was added to the desired solids concentration (˜20%) and mixed for 30 minutes. At this point, the ferment EPS was added and mixed for 10 minutes before proceeding. The amount of ferment added was calculated to give a level of EPS in the dry powder of 2.3%. The sample was homogenised for 5 minutes with a Silverson laboratory mixer/emulsifier at low speed. The sample was further mixed for 20 minutes at 50° C. with a Heidolph mixer, and homogenised with the Silverson mixer for 10 minutes. A 300 μm mesh sieve was used to remove any lumps,which were then crushed using a pestle and mortar and mixed back into the solution, which was sieved again.

The solution was maintained at 50° C. in a water bath before pumping to an Anhydro Lab S1 Spray Dryer (Denmnark) with an inlet temperature of 180° C. and an outlet temperature between 80-90° C. The feed rate was adjusted to ensure the outlet temperature was kept constant. The spray-dried powder was vacuum sealed in light- and moisture-impermeable bags. A control powder WMP powder containing no EPS was also prepared

The control and EPS containing powders were mixed to attain varied EPS concentrations. The measured powder was gradually added to RO water to obtain the desired total solids concentration (15%) and was mixed for 1 hour. The viscosities were measured using a Rheometric Scientific SR-5000 viscometer with cone and plate geometry (cone diameter 40 mm and cone angle 0.04 radians). Controlled stress sweeps were preformed with a 60 second delay before the test and an initial stress of 0.06 Pa.

The temperature was held at 5° C.

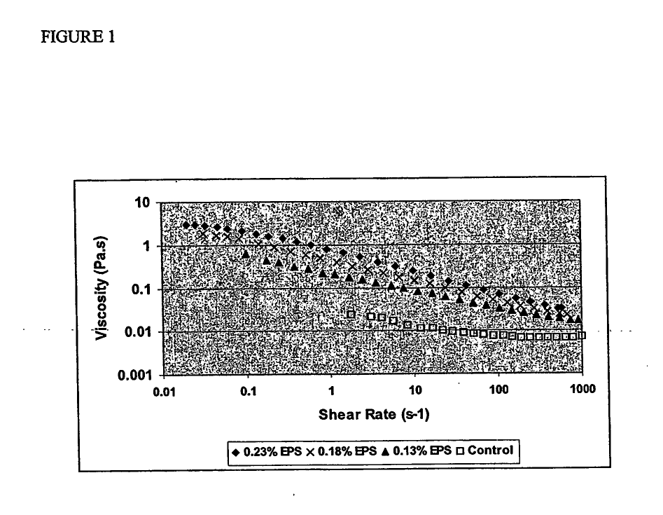

The milk solutions containing ferment broth EPS were more viscous than the control milk over the whole range of shear rates from 0.05 to 1000 s⁻¹, and particularly so at the low shear rates, which is characteristic of xanthan and other polysaccharides (FIG. 1).

The whole milk containing polysaccharide could be made into cheese by the addition of rennet and then draining the whey from the curds. It would be expected to give a higher yield of cheese curd than the control milk

### Example 4

Spray dried whole milk powder containing 2.71% Keltrol was used to discover the reaction of test panelists to milks containing EPS. The Keltrol was obtained CP Kelco, San Diego, USA, and was found to contain 84.8% xanthan EPS when analysed by the method detailed in Example 1. The powder was prepared by adding WMP to deionised water at 50° with vigorous stirring for 30 minutes to make a 20% solution. At this point, enough Keltrol was added to give a level of xanthan EPS in the finished powder of 2.3% and mixed for 10 minutes. The sample was homogenised for 5 minutes with a Silverson laboratory mixer/emulsifier at low speed. The sample was further mixed for minutes at 50° C. with a Heidolph mixer, and homogenised with the Silverson mixer for 10 minutes. A 300 μm mesh sieve was used to remove any lumps,which were then crushed using a pestle and mortar and mixed back into the solution, which was sieved again.

The solution was maintained at 50° C. in a water bath before pumping to an Anhydro Lab S1 Spray Dryer (Denmark) with an inlet temperature of 180° C. and an outlet temperature between 80-90° C. The feed rate was adjusted to ensure the outlet temperature was kept constant. The spray-dried powder was vacuum sealed in light- and moisture-impermeable bags. A control powder WMP powder containing no EPS was also prepared.

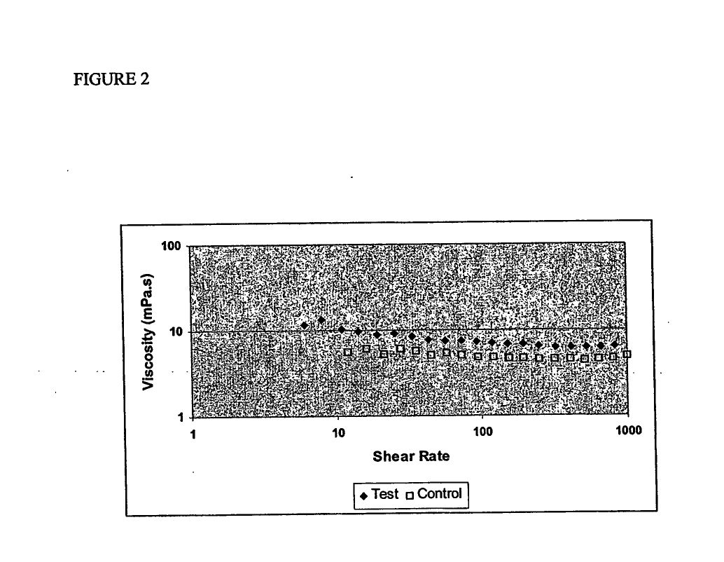

Two tests were carried out. In the first, the control and xanthan EPS containing powders were mixed to make a WMP powder containing 0.02% xanthan. This was reconstituted to a solids concentration of 13.3%. A reconstituted 15% WMP control milk was also prepared. The viscosities of both solutions were measured over a range of shear rates using a Rheometric Scientific SR-5000 viscometer with cone and plate geometry (cone diameter 40 mm and cone angle 0.04 radians). Controlled stress sweeps were preformed with a 60 second delay before the test and an initial stress of 0.06 Pa. The temperature was held at 5° C. The results are shown in FIG. 2.

It can be seen that the viscosity of the milk containing xanthan was slightly higher than the control, even though the xanthan milk was 2% lower in milk powder.

A triangle test was used to determine whether consumers could detect the difference between the two milks. Eleven of the 32 panelists tested correctly identified the different sample. Statistical analysis (Larmond, E. (1977). Laboratory Methods for Sensory Evaluation of Food. Canada Department of Agriculture Publication 1637. Kromar Printing Ltd.) showed that this result was not significant at the 5% level of confidence, and it can be concluded that the consumers could not tell the difference between the two samples. This showed that EPS, therefore, can substitute for WMP total solids, with 0.02% EPS replacing 1.7% of the total solids of a 15% WMP solution.

In the second test, spray dried WMP, containing xanthan EPS, was mixed with control WMP to obtain various EPS concentrations and reconstituted. The test samples had 15% solids containing xanthan EPS at levels of 0.015, 0.04, and 0.079%. The control consisted of a reconstituted WMP (no EPS) at 20% solids.

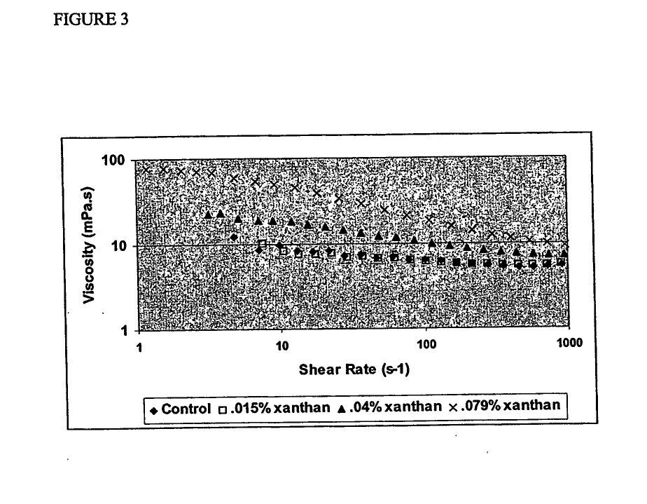

The viscosities of the milks were measured over a range of shear rates using a Rheometric Scientific SR-5000 viscometer and controlled stress sweeps at 21° C. (FIG. 3).

Thirty-two panelists were asked to compare the samples on a hedonic scale (like/dislike) for creaminess, thickness, flavour, and overall liking of the product. They were also asked to rate the samples on an intensity scale for creaminess and thickness.

Statistical analysis showed that hedonic ratings for the flavour and overall-liking attributes followed a binomial distribution. This was a reflection of people either liking or disliking the product. The people tested were not familiar with a thick milk product, and a large proportion disliked both the control and the test milks. A different result might be obtained with consumers accustomed to drinking thick milk.

The statistical analysis of the average hedonic ratings showed that there was no significant difference (5% level of confidence) between the four samples for flavour, overall liking, thickness and creaminess. Therefore the addition of xanthan EPS had no significant effect on the tasters' liking or disliking of the milk.

The intensity ratings for creaminess and thickness showed a normal distribution for all four samples. There was no significant difference between the ratings for thickness and creaminess of the control (20% WMP) and the test 15% WMP samples with 0.04% and 0.079% xanthan. However the control sample was perceived as thicker and creamier than the test 15% WMP samples with 0.015% xanthan. Evidently this level of xanthan is not sufficient to compensate for the difference of 5% in the solids level

### Example 5

Xanthomonas campestris ATCC 13951 was reconstituted from a lyophilized sample in ISP medium containing 5 g 1⁻¹ tryptone and 3 g 1⁻¹ yeast extract. It was maintained on YM agar slants at 4° C. (YM medium contained 3 g 1⁻¹ yeast extract, 3 g 1⁻¹ malt extract, 5 g 1⁻¹ peptone, and 10 g 1⁻¹ glucose, and, 20 g 1⁻¹ agar was used for the solid agar slants. The pre-fermenter seed-inoculum contained 1.2 g 1⁻¹ NH₄NO₃, 2 g 1⁻¹ K₂HPO₄, 0.1 g 1⁻¹ MgSO₄.7H₂O, and milk permeate (5% w/v lactose), pre-hydrolysed to glucose and galactose with Lactozyme 3000 L. The batch fermentation was undertaken in the same medium, with the exception that the milk permeate-lactose was not hydrolysed prior to fermentation, and antifoam (Bevaloid 6618, Rhodia) was used for foam-control. All media were adjusted to pH 7.

The inoculum was undertaken by the conventional protocol, in incremental steps equivalent to 10% (v/v) of the subsequent volume of culture. The inoculum was created by inoculation of 4×70 ml volumes of “YM” medium in a conical flask with a fresh culture of the organism preserved on a slant of YM agar, and cultivation of the cultures on an orbital shaker at a rotational speed of 180 rpm, at a temperature of 29° C. for 24 h. The cultures were subsequently transferred individually into 4×630 ml volumes of culture medium in 2 L conical flasks, incubated under the same conditions for 48 h, and pooled aseptically; this served as the seed-inoculum for the batch fermentation.

The total batch fermentation working volume was 55 L, consisting of 51 L milk permeate (approx. 5% w/v lactose) containing mineral salts, 0.9 L NH₄NO₃ stock solution (sterilized separately), 2.8 L of seed-culture, and the balance consisting of antifoam (55 ml), and enzyme solution. The fermentations were undertaken in an LH Bioreactor (60 L volume reactor). Temperature was controlled at 29° C., and the pH was maintained at 7.0 with 0.5 M KOH. Agitation was maintained at 700 rpm, higher agitation speeds were not feasible due to excessive foaming. Lactase enzyme solution was filtered into the fermenter vessel immediately after inoculation. After 72 h fermentation, the broth was transferred to chill storage.

The EPS concentration in the broth was found to be 0.252% as determined by the method outlined in Example 1. The broth was then ultrafiltered through a 10,000D cut-off Koch spiral-wound membrane until the volume was reduced to ˜2 L. It was diluted with distilled water and diafiltered until the retentate was virtually colourless and odourless. The EPS content of the retentate was found to be 0.593%.

An aliquot (130 g) of the retentate was diluted to 1 L and used to disperse 200 g of milk protein concentrate (MPC) powder (70% protein). The dispersion was then stirred with a Silverson mixer until the powder was completely dissolved. The solution was heated to 50° C. in a water bath before pumping to an Anhydro Lab S1 Spray Dryer (Denmark) with an inlet temperature of 180° C. and an outlet temperature between 80-90° C. The feed rate was adjusted to ensure the outlet temperature was kept constant. The spray-dried powder, containing 0.385% retentate EPS, was vacuum sealed in light- and moisture-impermeable bags. A control MPC powder containing no broth retentate was also prepared.

A concentrated emulsion of milk fat in MPC was made by mixing 20 g of the control MPC powder into the 480 g RO water at 50° C. for 30 minutes. Fresh frozen milk fat for recombining (500 g) was melted and added to the MPC solution and homogenised in a Silverson mixer at low speed until the mixture appeared homogeneous. It was then passed through a Rannie homogeniser at 70/50 bar at 45° C.

A control milk solution was then made by dissolving 121.5 g MPC in 378.5 g of RO water, heated to 50° C. The solution was stirred for 1 hour to ensure complete hydration.

A milk containing UF retentate was then made by dissolving 121.5 g MPC containing 0.385% broth retentate EPS in 378.5 g of RO water, heated to 50° C. The solution was mixed with a Heidolph RZR 50 stirrer for one hour and then passed through a 300 μm sieve to remove any lumps or foam. Any lumps present were ground with a pestle and mortar and added back to the solution which was mixed and passed through a 300 μm sieve. A lactic acid solution was made comprising 1.39% concentrated lactic acid and 98.61% RO water. Finally four cheese milks were mixed according to the proportions in Table 4.

TABLE 4
Formulation of cheese milks containing UF broth retentate

| Control | Retentate | | | Calcium | Lactic |
|---|---|---|---|---|---|
| Milk | Milk | Emulsion | NaCl | Lactate | Solution |
| Base (g) | (g) | (g) | (g) | (g) | (g) |
| 170 | 0 | 50 | 3.0 | 0.375 | 30 |
| 20 | 150 | 50 | 3.0 | 0.375 | 30 |
| 80 | 90 | 50 | 3.0 | 0.375 | 30 |
| 120 | 50 | 50 | 3.0 | 0.375 | 30 |

The milks were warmed to 38° C., mixed for 5 minutes, inoculated with 0.015% rennet (Christian Hansen, 540 IMCU/ml) and poured into pottles to the desired weight of cheese. The pottles were placed in a water bath at 38° C. for 40 minutes then the cheeses were left to cool overnight at 4° C.

The texture and expressed whey of the cheeses were measured in the same way as in Example 2, with the results shown in Table 5.

TABLE 5
The texture and firmness of experimental cheeses

| | | | | Final Cheese |
|---|---|---|---|---|
| MPC | Retentate EPS | Firmness | Whey Loss | Weight |
| % | % | N | % | g |
| 15.16 | 0 | 5.30 (0.39) | 19.45 (0.98) | 80.65 |
| 15.16 | 0.041 | 4.37 (0.12) | 16.86 (0.58) | 83.14 |
| 15.16 | 0.031 | 4.47 (0.10) | 17.00 (0.50) | 83.00 |
| 15.16 | 0.017 | 5.25 (0.14) | 17.60 (1.34) | 82.40 |

The cheeses made with MPC containing retentate EPS were softer and lost less whey than the control cheese. Starting with 100 g of fresh cheese the control only weighed 80.65 g after syneresis, whereas the cheeses containing EPS weighed 82 to 83 g. It is evident that if MPC containing retentate EPS is used to make a fresh white cheese less MPC is required to make a cheese of equivalent weight after drainage.

### Example 6

A mother culture of Lactobacillus delbrueckii ssp bulgaricus, ACC strain 2483, was prepared by inoculating a bottle of sterilised milk (10 g skim milk powder (SMP) in 90 g RO water) with the organism, under sterile conditions. After inoculation, the bottle was incubated at 37° C. for about 18 hours, after which time it had turned to a thick gel. The inoculum was kept in a refrigerator until needed for the main experiment. 2 L round-bottomed flask and attachments was sterilised in an electric steriliser. Then the flask was secured in a waterbath at 37° C. and fitted with a pH stat, stirrer and feed from a peristaltic pump, primed with a suspension of calcium carbonate.

Milk permeate (1.1L) with 5.5 g of SMP and 5.5 g yeast extract (GibcoBRL) was heaed to boiling and then allowed to cool to 37° C. Some of the solution was reserved for later viscosity measurements, and the bulk of the medium was added to the round-bottomed flask. Stirring was started at a slow speed, just sufficient to move the liquid without creating a vortex. Mother culture (10 ml) was added and the flask. resealed. When the pH had dropped to 6, the pH stat and peristaltic pump were started.

The fermentation was allowed to continue for about 18 hours, by which time the pH had fallen to 4.8. The injection of calcium carbonate was insufficient to stabilise the pH at 6, which had been the original intention. The broth was then heated to 90-100° C. for a few minutes, cooled and stored in a refrigerator.

The viscosity of the broth was measured with a U-tube viscometer, which had been standardised with RO water, at 20° C. The relative viscosity was 1.79, compared to 1.22 for the original uninoculated medium.

The increase in relative viscosity indicated that some EPS had been formed during the fermentation, so the concentration of EPS was measured by the method in Example 1. The EPS concentration was found to be 0.1 g/kg of broth.

The remaining broth was adjusted to pH 6.5 by the slow addition of calcium oxide. After filtering the broth, it was used to dissolve 100 g of whole milk powder (WMP). The resulting milk was heated to 50° C. in a water bath and then pumped to an Anhydro Lab S1 Spray Dryer (Denmark) with an inlet temperature of 180° C. and an outlet temperature between 80-90° C. The feed rate was adjusted to ensure the outlet temperature was kept constant. The spray-dried powder was vacuum sealed in light- and moisture-impermeable bags. A control WMP without broth was also prepared. The level of EPS in the WMP was estimated to be 0.1%.

Solutions (15% solids) of the two spray-dried powders in deionised water were tested in a Ferranti-Shirley viscometer, using a 100 mm cone and a shear sweep from 0 to 935 s⁻¹. The apparent viscosity(V₁₀₀) at 100 s⁻¹, the consistency coefficient(K) and the flow behaviour index (n) were calculated from the power law equation and shown in Table 6.

| | V₁₀₀ | K | |
|---|---|---|---|
| System | Pa · s | Pa · s | N |
| Control milk | 0.008 | 0.024 | 0.776 |
| Milk with EPS | 0.021 | 0.349 | 0.39 |

The above Examples are illustrations of practice of the invention. It will be appreciated by those skilled in the art that the invention can be carried out with numerous modifications and variations. For example the type of microorganism used may be varied. The microorganisms used may be producers of different exopolysaccharides. The fermentation media, carbon source and times and temperatures may be varied. The heat-killed ferments may be used to different types of cheeses and cheese-like products.

1. A method of preparing or modifying a cheese or cheese-like product comprising mixing into a cheesemaking mixture or product, a heat-killed ferment of an exopolysaccharide-producing-microorganism without separating the exopolysaccharide from the other components of the ferment.

2. A method as claimed in claim 1 wherein the heat-killed ferment is directly mixed into a cheesemaking mixture.

3. A method as claimed in claim 1 wherein the heat-killed ferment is mixed into an ingredient used in making the product.

4. A method as claimed in claim 1 wherein the heat-killed ferment is ferment prepared using a lactose-rich medium and an exopolysaccharide-producing-microorganism.

5. A method as claimed in claim 1 wherein the microorganism does not hydrolyse lactose, and the ferment comprises an added lactase or galactosidase enzyme or an organism which produces an enzyme which hydrolyses lactose.

6. A method as claimed in claim 4 wherein the medium contains more than 1.0% (w/v) lactose.

7. A method as claimed in claim 4 wherein the lactose-rich medium is a fraction of milk.

8. A method as claimed in claim 7 wherein the fraction is serum or mother liquor; or raffinate or breakthrough derived from milk or skim milk or buttermilk or whey or serum or mother liquor or permeate; or permeate derived from milk or skim milk or buttermilk or whey or serum or mother liquor or raffinate or breakthrough.

9. A method as claimed in claim 1 wherein the microorganism is a food-acceptable microorganism.

10. A method as claimed in claim 8 wherein the lactose-rich medium comprises a dairy permeate.

11. A method as claimed in claim 10 wherein the dairy permeate is a milk permeate or a whey permeate.

12. A method a claimed in claim 1 wherein the microorganism is selected from Xanthomonas compestris, Sphingomonas paucimobilis and lactic acid bacteria.

13. A method as claimed in claim 11 wherein the microorganism is selected from Xanthomonas compestris and Sphingomonas paucimobilis.

14. A method as claimed in claim 11 wherein the microorganism is selected from Lactobacillus delbrueckii ssp bulgaricus; Lactococcus lactis ssp cermoris; Lactococcus lactis ssp lactis; Streptococcus salivarius ssp thermophilus; Lactobacillus casei ssp casei; Leuconostoc mesenterodies; lactobacillus helvitius; Lactobacillus reuteri; Lactobacillus rhamnosus; Lactobacillus plantarum and Lactobacillu sakei.

15. A method as claimed in claim 1 wherein fermentation is conducted at a temperature of 20-35° C.

16. A method as claimed in claim 14 wherein the fermentation is incubated for 16-240 hours.

17. A method as claimed in claim 15 wherein the mixture is fermentation incubated for 60-120 hours.

18. A method a claimed in claim 1 wherein the ferment is heated and spray dried.

19. A method as claimed in claim 1 wherein ferment is heat-killed and mixed directly with a dairy product.

20. A method of modifying a milk protein concentrate comprising adding to the concentrate a heat-killed ferment of an exopolysaccharide-producing-microorganism without separating the exopolysaccharide from the other components of the ferment.

21. A method of preparing a cheese or cheese-like product comprising the steps of
(a) adding to a cheese milk, a heat-killed ferment of an exopolysaccharide-producing-microorganism without separating the exopolysaccharide from the other components of the ferment;
(b) adding a proteolytic enzyme to the mixture;
(c) collecting the resulting curd;
(d) further processing the curd to produce a cheese or cheese-like product.

22. A process of preparing a cheese or cheese-like product comprising the steps of
(a) providing a cheese precursor mixture comprising milk proteins
(b) adding to the cheese precursor mixture a heat killed ferment of an exopolysaccharide-producing-microorganism without separating the exopolysaccharide from the other components of the ferment
(c) providing conditions under which the product gels.

23. A method as claimed in claim 22 wherein the conditions of (c) are provided by cooking the mixture to denature milk proteins and allowing the mixture gel.

24. A method as claimed in claim 1 wherein the product is a cheese.

25. A method as claimed in claim 1 wherein the product is a processed cheese.
